(19) United States
(12) Patent Application Publication
(10) Pub. No.: US 2024/0288997 A1
(43) Pub. Date: Aug. 29, 2024

(54) METHOD, APPARATUS, DEVICE AND STORAGE MEDIUM FOR INTERFACE SWITCHING

(71) Applicant: Beijing Zitiao Network Technology Co., Ltd., Beijing (CN)

(72) Inventor: Zhaoying LI, Beijing (CN)

(21) Appl. No.: 18/571,317

(22) PCT Filed: Sep. 7, 2022
(86) PCT No.: PCT/CN2022/117490

§ 371 Date: Dec. 18, 2023

(30) Foreign Application Priority Data
Sep. 9, 2021 (CN) 202111057312.2

(51) Int. Cl. G06F 3/0484; G06F 3/04886

(52) U.S. Cl. CPC G06F 3/0484; G06F 3/04886

(57) ABSTRACT

The disclosure provides a method, apparatus, device and storage medium for interface switching. The method includes: in response to determining that a first interface is currently displayed in a preset application, receiving a swiping operation for the first interface and determining a target action area corresponding to the swiping operation, and in response to the swiping operation, switching to display a target interface, an interface type of the first interface is a first type; in response to determining that the target action area is a first preset area, the target interface is a second interface, and in response to determining that the target action area is a second preset area, the target interface is a third interface, an interface type of the second interface is the first type, and an interface type of the third interface is a second type, and the first type and the second type are different.

### CROSS-REFERENCE

This application claims priority to the Chinese patent application filed with the Chinese Patent Office on Sep. 9, 2021, with application No. 202111057312.2, the entire contents of which are incorporated herein by reference.

### FIELD

The present disclosure relates to the field of computer technology, for example, to a method, apparatus, device and storage medium for interface switching.

### BACKGROUND

With the rapid development of computer technology, the functions in applications (APPs) are becoming more and more abundant, and there are more and more interfaces included in an application. Different interfaces may allow users to view different contents, and users can switch between different interfaces through various gesture operations according to their own needs.

Currently, in the same application, there may be different types of interfaces, and there may be requirements on switching between interfaces of the same type and between interfaces of different types.

### SUMMARY

The present disclosure provides a method, apparatus, storage medium and device for interface switching, which can improve the interface switching scheme in the related art.

In a first aspect, the present embodiment provides a method for interface switching, including:
in response to determining that a first interface is currently displayed in a preset application, receiving a swiping operation for the first interface and determining a target action area corresponding to the swiping operation, wherein an interface type of the first interface is a first type, and the first interface contains a first preset area and a second preset area; and
in response to the swiping operation, switching to display a target interface, wherein, in response to determining that the target action area is a first preset area, the target interface is a second interface, in response to determining that the target action area is a second preset area, the target interface is a third interface, an interface type of the second interface is the first type, and an interface type of the third interface is a second type, and the first type and the second type are different.

In a second aspect, the present embodiment provides an apparatus for interface switching, including:
an action area determining module configured to, in response to determining that a first interface is currently displayed in a preset application, receive a swiping operation for the first interface and determine a target action area corresponding to the swiping operation, wherein an interface type of the first interface is a first type, and the first interface contains a first preset area and a second preset area; and
an interface switching module configured to, in response to the swiping operation, switch to display a target interface, wherein, in response to determining that the target action area is a first preset area, the target interface is a second interface, in response to determining that the target action area is a second preset area, the target interface is a third interface, an interface type of the second interface is the first type, and an interface type of the third interface is a second type, and the first type and the second type are different.

In a third aspect, the present disclosure provides a computer-readable storage medium having a computer program stored thereon, the computer program implements the method for switching an interface as provided in the embodiment of the present disclosure.

In a fourth aspect, the present disclosure provides an electronic device comprising a memory, a processor and a computer program, the computer program is stored on the memory and is runnable on the processor, and the processor implements the method for switching an interface as provided in the embodiment of the present disclosure.

### BRIEF DESCRIPTION OF THE DRAWINGS

FIG. 1 is a schematic flowchart of a method for switching an interface provided by an embodiment of the present disclosure;

FIG. 2 is a schematic diagram illustrating interface switching in related art;

FIG. 3 is a schematic flowchart of another method for switching an interface provided by an embodiment of the present disclosure;

FIG. 4 is a schematic diagram illustrating interface area division provided by an embodiment of the present disclosure;

FIG. 5 is a schematic diagram illustrating an interface provided by an embodiment of the present disclosure;

FIG. 6 is a schematic diagram illustrating another interface provided by an embodiment of the present disclosure;

FIG. 7 is a schematic diagram illustrating interface switching provided by an embodiment of the present disclosure;

FIG. 8 is a schematic diagram illustrating another interface switching provided by an embodiment of the present disclosure;

FIG. 9 is a structural block diagram of an apparatus for switching an interface provided by an embodiment of the present disclosure; and

FIG. 10 is a structural block diagram of an electronic device provided by an embodiment of the present disclosure.

### DETAILED DESCRIPTION

It should be understood that a plurality of steps described in the method implementation of this disclosure can be executed in different orders and/or in parallel. In addition, the method implementation can include additional steps and/or omit the steps shown. The scope of this disclosure is not limited in this regard.

The term “including” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concept of “first” and “second” mentioned in this disclosure are only used to distinguish different apparatuses, modules, or units, but are not used to limit the order or interdependence of the functions performed by these apparatuses, modules, or units.

The modifications of “one” and “a plurality of” mentioned in this disclosure are illustrative but not limiting. Those skilled in the art should understand that unless otherwise indicated in the context, they should be understood as “one or more”.

The names of the messages or information interacted between a plurality of apparatuses in this public implementation are for illustrative purposes only, which are not intended to limit the scope of these messages or information.

In the following plurality of embodiments, each embodiment provides exemplary features and examples, a plurality of features described in the embodiments may be combined to form a plurality of exemplary solutions, each numbered embodiment should not be regarded as only one technical solution.

As mentioned above, there may be different types of interfaces, and there may be requirements on switching between interfaces of the same type and between interfaces of different types. However, according to the interface switching scheme in related art, it is difficult to balance the two switching requirements while ensuring operational convenience, and thus improvements are needed. To this end, the embodiments of the present disclosure provide a solution for switching an interface.

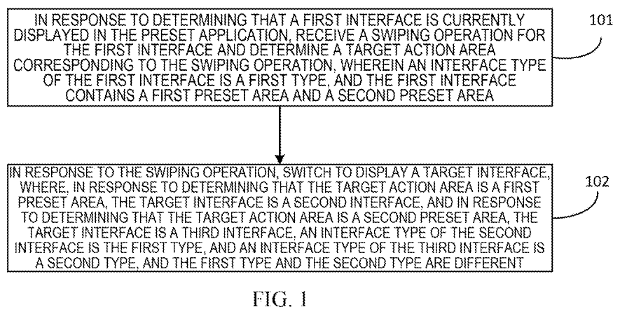

FIG. 1 is a schematic flowchart of a method for switching an interface provided by the embodiment of the present disclosure. The method can be performed by an apparatus for switching an interface, which can be implemented by software and/or hardware and can generally be integrated into an electronic device. The electronic device can be a mobile device such as a mobile phone, a smart watch, a tablet computer, and a personal digital assistant, etc.; it can also be other devices such as a desktop computer. As shown in FIG. 1, the method includes:
Step 101, in a case that a first interface is currently displayed in the preset application, receiving a swiping operation for the first interface and determining a target action area corresponding to the swiping operation, wherein an interface type of the first interface is a first type, and the first interface contains a first preset area and a second preset area.

In this embodiment of the present disclosure, the type of the preset application is not specifically limited, for example, it may be short video applications, i.e., instant messaging applications or LIVE applications, etc., and it may also be other types of applications. An interface type of the first interface is the first type, and division of interface type and the specific type for the first type are not limited here. It can be set according to actual needs of the preset application. For example, the first type includes a plurality of interfaces at the same level that can be switched sequentially by the swiping operation, such as a plurality of tabs included in a homepage of the application, such as For You tab and Following tab, etc. The preset application can include at least two interfaces of the first type, and the specific number of the interfaces is not limited here. The content to be displayed on the first interface is not limited, and the source and push mechanism of the content to be displayed can be designed by the developer. The first interface can be any interface of the first type or a specified interface in interfaces of the first type. The condition or timing for triggering the display of the first interface is not limited. Generally, different interfaces of the first type can be distinguished by interface identifiers (interface tags for interfaces of tab type). The interface identifier can also be used to indicate a source and push mechanism of the content displayed in the interface of the first type. The interface identifier can be a specific icon or text, etc. The interface identifier can be displayed in a designated area of the interface of the first type. For interfaces of tab type, the designated area can be a tab bar set at the top area of the interface.

For an interface of first type, the first preset area and the second preset area are set. The first preset area and the second preset area generally do not intersect with each other, that is, there is generally no overlap area between the first preset area and the second preset area. Part of the boundary of the first preset area can be connected to part of the boundary of the second preset area. For interfaces of tab types, the first preset area and the second preset area generally do not include a tab bar at the top area of the interface and the navigation bar at the bottom area of the interface. For example, the area of the first preset area is greater than that of the second preset area.

For example, the way in which the user inputs the swiping operation can be related to the type of electronic device. For electronic devices that support touch operations, the swiping operation can be input on the screen by pressing and swiping with fingers or stylus pens; for other electronic devices, the swiping operation can also be input with input device such as a mouse. The electronic device may receive the swiping operation for the first interface according to the input method for the supported touch operation. Currently, electronic devices that support touch operations are quite popular. For ease of explanation, a swiping operation by the finger touching the screen is used as an example for subsequent explanation. A target action area corresponding to the swiping operation can include an area where the action starting point of the swiping operation is located, or the target action area includes an area where an action trajectory of the swiping operation is located. Taking a swiping operation performed by the finger as an example, a swiping gesture can be broken down into three stages: touching the screen or pressing the screen, holding and dragging, and leaving the screen. A position of the finger when touching the screen or pressing the screen can be regarded as an action starting point, the corresponding dragging trajectory during the holding and dragging process can be regarded as the action trajectory, and a position of the finger when leaving the screen can be regarded as the action end point. A direction of the swiping operation is generally horizontal or vertical, which can be set according to actual needs. For example, for interfaces of tab types, interface tags are generally displayed in the tab bar in a horizontal arrangement, and the direction of swiping operation can be horizontal, which is in consistent with the layout direction of interface tags, thus it is more in line with the user's visual habits.
Step 102, in response to the swiping operation, switching to display a target interface, where, in a case that the target action area is a first preset area, the target interface is a second interface, in a case that the target action area is a second preset area, the target interface is a third interface, an interface type of the second interface is the first type, and an interface type of the third interface is a second type, and the first type and the second type are different.

In the embodiment of the present disclosure, an interface of the second type may be associated with a preset interface of the first type, the specific association may be determined based on the content being displayed in the interface of the first type and the content contained in the interface of the second type.

For example, the interface of the second type is an interface that at least one interface of the first type is switched to when the target action area corresponding to the swiping operation is the first preset area. That is, a part of the interfaces of the first type in this disclosure are switched to interfaces of the second type when the target action area corresponding to the swiping operation is the first preset area or the second preset area, while another part of the interfaces of the first type can only be switched to the interface of the second type by a swiping operation when corresponding target action area is the second preset area. For example, an interface of the second type can be an interface associated with the contents displayed on the interface of the first type, such as the personal homepage of the content author or the contents associated with the work contents. In related art, some interfaces in a plurality of tabs included in the homepage, such as the leftmost or rightmost tabs, can enter the personal homepage by a swiping operation, but other tabs in the homepage cannot enter the personal homepage by a swiping operation. Through the technical solution of this disclosure, by a swiping operation to distinguish the first preset area and the second preset area on other tabs of the homepage, the other tabs can also easily enter the personal homepage by a swiping operation.

For example, after determining the target action area corresponding to the swiping operation, whether the target action area is the first preset area or the second preset area can be determined first. If the target action area is the first preset area, after the swiping operation is completed, it can respond to the swiping operation and the second interface is switched to display, that is, performing switching between interfaces of the same type. A specific interface to switch to can be determined from the interfaces of the first type according to the first preset switching rule. The first preset switching rule can be set according to actual needs, for example, it can be determined according to the position of the interface identifier corresponding to the first interface, or it can be any interface of the first type other than the first interface. Taking that the first type is the tab type as an example, the interface corresponding to the next interface tag in the tab bar (in an order opposite to the swiping direction) can be determined as the second interface. For example, if the swiping direction is from right to left, the interface corresponding to the next interface tag in the order from left to right is determined as the second interface. If the interface tag on the first interface is the last interface tag in the tab bar in the order opposite to the swiping direction, the interface corresponding to the first interface tag in the tab bar in the order opposite to the swiping direction can be determined as the second interface. If the target action area is the second preset area, after the swiping operation is completed, the swiping operation may be responded to and the third interface is switched to be displayed, that is, switching between different types of interfaces is performed. Among them, the number of interfaces of the second type is one or more. If there are more than one interfaces of the second type, a specific interface to switch to can be determined from the interfaces of the second type according to the second preset switching rule, and the second preset switching rule can be set according to actual needs.

It should be noted that when switching between two interfaces, the specific switching process is not limited. The switching process may include transiting from one interface to another, that is, there is a time when both of the two interfaces have some contents displayed at the same time, or there may be a direct change from one interface to another.

For example, if the target action area is not the first preset area or the second preset area, other responding methods can be pre-set or the swiping operation may not be responded.

The method for switching an interface provided in the embodiment of the present disclosure includes: in a case where the first interface is currently displayed in the preset application, receiving a swiping operation for the first interface and determining a target action area corresponding to the swiping operation, and in response to the swiping operation, switching to display a target interface, where an interface type of the first interface is a first type, the preset application program includes at least two interfaces of the first type and the first interface contains a first preset area and a second preset area. In a case where the target action area is the first preset area, the target interface is the second interface; and in a case where the target action area is a second preset area, the target interface is a third interface; an interface type of the second interface is the first type, and an interface type of the third interface is a second type. By adopting the above technical solution, different forms of interface switching can be performed using the swiping operation, and whether switching between interfaces of the same type or between interfaces of different types can be determined according to the target action area corresponding to the swiping operation, which ensures the convenience of operation, and at the same time meets different switching needs, and improves the interface switching efficiency as well as the application performance.

In some embodiments, before switching to display the third interface, the method further includes: displaying swiping prompt information within a first preset range corresponding to the second preset area, wherein the swiping prompt information includes swiping direction information and/or swiping result indication information, and the swiping result indication information is configured to indicate that it is about to switch to display the third interface. Currently, the swiping operation is mostly configured for switching between interfaces of the same type, and generally users may not be familiar with switching between different types of interfaces, thus by displaying the swiping prompt information, the user may be reminded, so as to help the user quickly grasp the new switching method.

For example, the display method and the timing of swiping prompt information are not limited, for example, they can be displayed in legend or text form, and can be displayed when entering the first interface or when the user's need for switching to the third interface is identified. The first preset range can be designed according to the actual situation, for example, it can be included in the second preset area, or it may include the second preset area, or it may be a set range adjacent to the second preset area.

For example, the displaying the swiping prompt information within the first preset range of the second preset area includes: after detecting a touch operation acting on the second preset area, displaying the swiping prompt information within a preset range of the second preset area. The touch operation can be understood as an operation of pressing the screen and not lifting. At this time, the user has the condition for inputting a swiping operation for switching to the third interface, thus the user may be reminded in time. If the user wants to enter the third interface, he/she does not need to lift the finger, but can directly slide his finger according to the swiping prompt information to switch to display the third interface, which improves the reminder effect and improves the interface switching efficiency.

In some embodiments, a first preset control in the first interface is displayed in the second preset area, and in a case that the target action area is the second preset area, an action starting point of the swiping operation falls within an associated range of a display area corresponding to the first preset control, and the associated range includes the display area. This allows to reuse the first preset control in the first interface to effectively identify the second preset area, which facilitates the user to quickly locate the second preset area.

As an example, the first interface generally contains some controls for users to input interactive operations. The methods for triggering these controls generally include a clicking operation, that is, an operation that the user presses and then lifts, which does not conflict with the swiping operation. When the action starting point of the swiping operation falls within the associated range of the display area corresponding to the first preset control, the target action area corresponding to the swiping operation can be considered as the second preset area. The associated range can be a range obtained by expanding the preset distance around the display area. The specific expanding method can be determined according to the shape of the first preset control. If the first preset control is circular, the associated range can be the range of a concentric circle with a larger radius.

In some embodiments, before switching to display the third interface, the method further includes: controlling the first preset control to move and display within a second preset range corresponding to the second preset area by following the swiping operation. This can enhance the fun of interface switching.

For example, when the action starting point of the swiping operation falls into the display area corresponding to the first preset control, if the swiping is continuously performed, the first preset control follows the swiping operation to move and display within a second preset range corresponding to the second preset area, which visually provides an effect that the first preset control is being dragged and thus enhance the interests. The specific way in which the first preset control follows the swiping operation to move and display is not limited, for example, the swiping direction and swiping speed of the swiping operation can be determined, and the first preset control moves and displays in the swiping direction according to the swiping speed. It should be noted that the swiping direction can be consistent with the direction of the user's finger movement, or there may be a small range of angles therebetween. Generally, the swiping direction is in parallel to the edge of the screen; the moving speed of the first preset control can be proportional to the swiping speed. The first preset control can be selected according to actual needs, generally, controls that are associated with the third interface can be selected. The second preset range can be designed according to the actual situation, for example, the second preset range may be included in the second preset area, or it may include the second preset area, or it may be a preset area adjacent to the second preset area.

For example, the display of swiping prompt information and the move and display of the first preset control can be combined. At this time, the first preset range can be the same as the second preset range. As an example, the first preset range includes the first preset control, and the swiping prompt information and the first preset control can be displayed simultaneously within the first preset range. During the move and display process of the first preset control, the display position and/or display content of the swiping prompt information can be adaptively adjusted.

In some embodiments, the preset application is installed in the mobile terminal, and the second preset area is associated with the gripping mode when the user grips the mobile terminal. This facilitates the user to quickly and accurately input swiping operation for switching between interfaces of different types. The second preset area can be located, for example, in an easy-to-operate area corresponding to the gripping mode. The easy-to-operate area can be determined in many ways. For example, user groups can be investigated for the gripping mode and posture in which the user grips the mobile terminal of different models or shapes, and a screen area that is easy to operate for most users is set as the easy-to-operate area. For example, when the user starts to use a preset application, a gripping mode entry function can be entered according to user's selection, and the user may enter his/her easy-to-operate area by himself/herself and set this area as the easy-to-operate area. For example, when selecting the first preset control, the easy-to-operate area may also be referred to, and the first preset control is selected from the controls in the easy-to-operate area.

In some embodiments, the method further includes: determining a corresponding second preset area according to the gripping mode in which the user grips the mobile terminal, wherein the gripping mode includes at least one of left hand gripping and right hand gripping. When the user's gripping mode is different, the easy-to-operate area may also be changed, and the second preset area is dynamically and flexibly determined according to the gripping mode, which is convenient for the user to operate.

In some embodiments, the method further includes: displaying a second preset control in the determined second preset area in the first interface, where, in a case that the target action area is a second preset area, the action starting point of the swiping operation falls within a display area corresponding to the second preset control, the second preset control is determined based on the gripping mode in which the user grips the mobile terminal. Using the second preset control to identify the dynamically determined second preset area can facilitate the user to quickly locate the dynamically changed second preset area, and flexibly determining the second preset control based on the gripping mode in which the user grips the mobile terminal can avoid significant changes in the position of the second preset control and thus facilitate the user to quickly find the second preset control. At this time, the second preset control can be the same as the first preset control or can be different from the first preset control. As an example, the corresponding easy-to-operate area can be determined based on the gripping mode in which the user grips the mobile terminal, and the control closest to the center point of the easy-to-operate area is determined as the second preset control.

Currently, short video applications have been increasingly favored by more and more users. Users may browse various short video contents in short video applications. Taking short video applications as an example, the first type can be a tab type, and the second type can be a type other than a tab type, which can be an independent interface type. For example, interfaces of the first type may include For You tab and Following tab, as well as regional tabs. In a For You tab, short videos are recommended to the user according to preset rules, in a Following tab, short videos published by short video authors that the user follows are recommended to the user, and in a regional tab, short videos published by short video authors in a region where the user is located are recommended to the user. The user may switch between a plurality of interfaces of the first type according to their actual needs. The interface of the second type can be associated with the contents displayed in an interface of the first type, for example, it may be a personal homepage of a short video author. For example, the personal homepage may contain short videos published by the short video author. The association between the short video being displayed on the For You tab or Following tab and its corresponding personal homepage is that the author of the short video being displayed is the same as the author of the short video contained in the personal homepage. When a user views a short video of a certain short video author on the For You tab or Following tab, if he/she want to further view other short videos published by the short video author, he/she may switch to the personal homepage of the short video author for viewing.

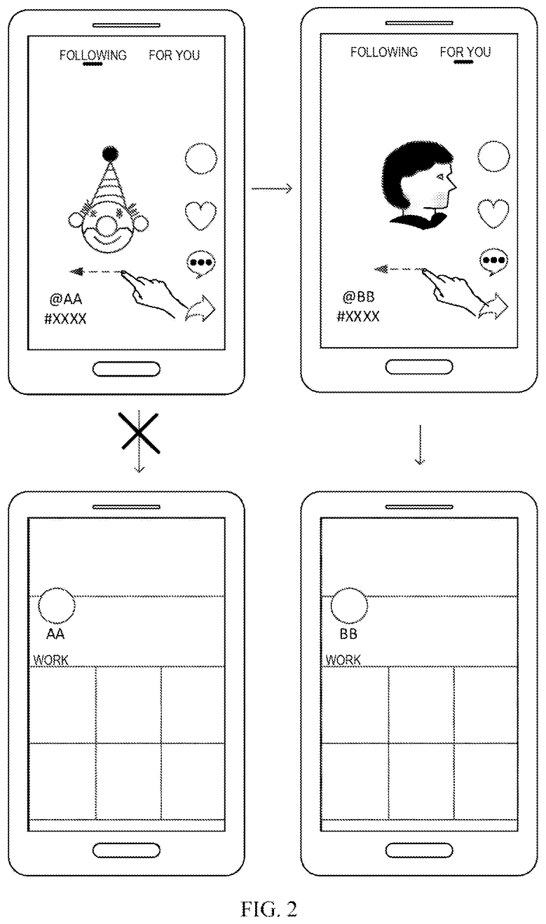

FIG. 2 is a schematic diagram of interface switching in related art. As shown in FIG. 2, when a Following tab is currently displayed, a For You tab may be switched to by the user through inputting a right-to-left swiping operation. When a For You tab is currently displayed, a personal homepage of the author BB of the short video being played in the For You tab may be switched to by the user inputting a right-to-left swiping operation. However, when the Following tab is currently displayed, if the user wants to switch to the personal homepage of the author AA of the short video being played in the Following tab, the switch cannot be realized by inputting a swiping operation, and then other forms of operation has to be designed, which cannot meet the user's swipe operation habits.

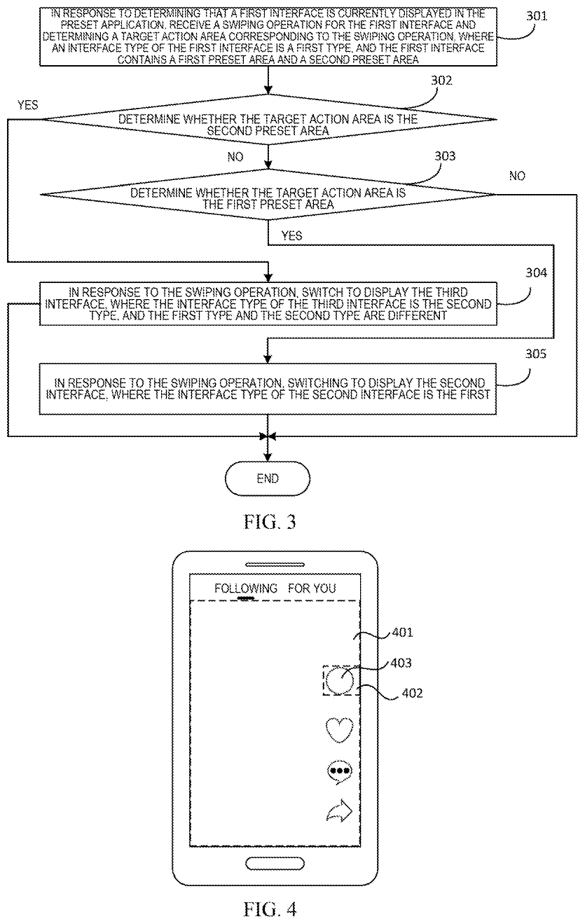

FIG. 3 is a schematic flowchart of another method for switching an interface provided by an embodiment of the present disclosure. The embodiment of the present disclosure is refined based on a plurality of exemplary solutions in the above embodiments. By taking that the preset application is a short video application as an example, the method includes the following steps, for example:
Step 301, in a case that a first interface is currently displayed in the preset application, receiving a swiping operation for the first interface and determining a target action area corresponding to the swiping operation, where an interface type of the first interface is a first type, and the first interface contains a first preset area and a second preset area.

For example, for short video applications, the first type can be a tab type. An interface of the first type may include a For You tab and a Following tab, and the corresponding interface tags can be For You and Following respectively. An interface of second type is a personal homepage of a short video author, that is, the author of the short video being displayed in the interface of first type is the same as the author in the interface of the second type. Taking that the first interface is the Following tab as an example, FIG. 4 is a schematic diagram illustrating interface area division provided by this embodiment of the present disclosure. As shown in the drawings, the first interface includes a first preset area 401 and a second preset area 402. There is no intersection between the first preset area 401 and the second preset area 402. A first preset control 403 is displayed in the second preset area 402. For example, the first preset control 403 is a profile picture control, and a profile picture of the author of the short video being played in the first interface is displayed in the profile picture control.

For example, a short video application is installed in a mobile terminal such as a mobile phone. Before this step, the method may further include: obtaining a gripping mode in which the user grips the mobile terminal, determining a corresponding second preset area according to the gripping mode, and displaying the first preset control in the determined second preset area in the first interface. For example, when the user grips the mobile terminal with the right hand, the easy-to-operate area includes the left area of the screen, and when the user grips the mobile terminal with the left hand, the easy-to-operate area includes the right area of the screen. The position of the second preset area corresponding to the left hand gripping is shown in FIG. 4. If the user grips the mobile terminal with the right hand, the first preset area 401 and the first preset control 403 therein can be displayed on the left side of the screen.

For example, the target action area corresponding to the swiping operation may include the area where the action starting point of the swiping operation is located.
Step 302, determining whether the target action area is the second preset area or not, performing the step 304 based on a determination result that the target area is the second preset area, and performing the step 303 based on a determination result that the target area is not the second preset area.

It should be noted that it is also possible to determine whether it is the first preset area or whether it is an area outside the first preset area and the second preset area, which is not specifically limited here.

For example, if a touch operation acting on the second preset area is detected, the swiping prompt information is displayed within the first preset range of the second preset area. FIG. 5 is a schematic diagram of an interface provided by the embodiment of the present disclosure. As shown in FIG. 5, when the user touches a profile picture control but not lift the finger, a label bar 501 can be displayed. The display area corresponding to the label bar 501 can be considered as the first preset range. The swiping prompt information is displayed in the label bar 501, where the swiping prompt information includes swiping direction information, indicated by the arrow in the drawing. The swiping prompt information also includes swiping result indication information “Swipe into homepage”, which is configured to indicate that it is about to switch to the personal homepage of the short video author corresponding to the profile picture, that is, the third interface.

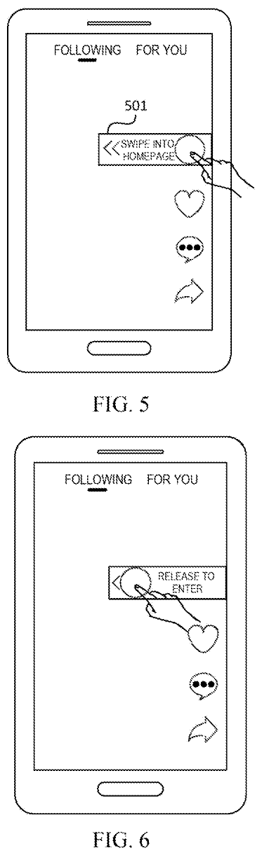

For example, the method may further include: controlling the first preset control to move and display within a second preset range corresponding to the second preset area by follow the swiping operation. FIG. 6 is a schematic diagram illustrating another interface provided by the present disclosure. As shown in FIG. 6, as the user's finger slides, the profile picture control may move and display within the display area corresponding to the label bar (at this time, the first preset range can be the same as the second preset range) by following the swiping operation. In addition, the content and display position of the swiping prompt information may also be adjusted accordingly. For example, when the profile picture moves to the left side of the label bar, the swiping result indication information is adjusted to “Release to enter”.
Step 303, determining whether the target action area is the first preset area or not, performing the step 305 based on a determination result that the target action area is the first preset area, and based on a determination result that the target action area is not the first preset area, the process ends.

For example, if the target action area is not the second preset area or the first preset area, the process can be ended and the swiping operation may not be responded to. Of course, other strategies can also be used to respond to the swiping operation, which is not limited here.
Step 304, in response to the swiping operation, switching to display the third interface, where the interface type of the third interface is the second type, and the first type and the second type are different.

For example, when the user releases his/her finger and the swiping distance corresponding to the swiping operation reaches a preset distance threshold, the swiping operation can be considered as valid and can be responded to.

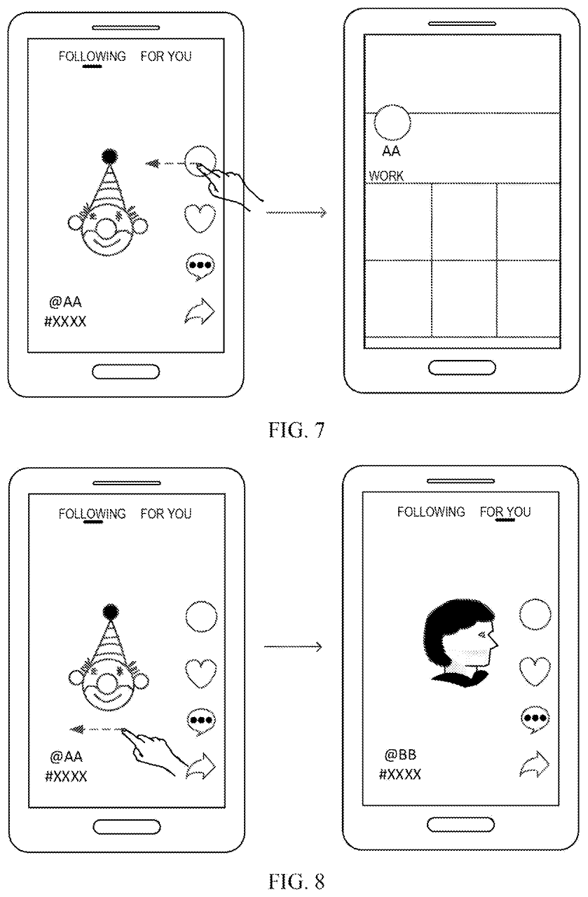

FIG. 7 is a schematic diagram illustrating interface switching provided by the present disclosure embodiment. As shown in FIG. 7, since the corresponding target action area is the second preset area, it is possible to switch to the personal homepage of the author AA of the short video being played in the Following tab.
Step 305, in response to the swiping operation, switching to display the second interface, where the interface type of the second interface is the first type.

FIG. 8 is a schematic diagram illustrating another interface switching provided in the present disclosure embodiment, as shown in FIG. 8, since the corresponding target action area is a first preset area, and the next tab interface can be switched to, i.e., the For You tab.

For short video applications, the method for switching an interface provided by the disclosed embodiment can use swiping operations acting on different areas to achieve switching between tabs and switching between tabs and personal homepages, which solves gesture conflicts, conform to the user's habits for swiping operations, and improve interface switching efficiency. In addition, since there is a certain correlation between the profile picture and the personal homepage, reusing the profile picture control to effectively identify the second preset area facilitate users to quickly locate the second preset area, which further improves interface switching efficiency. The design of the label bar can help users quickly understand the switching method between interfaces of different types, and the profile picture can be moved and displayed by following the swiping gesture, which enhance the fun of interface switching.

FIG. 9 is a block diagram of an apparatus for switching an interface provided in the present disclosure, which can be implemented by software and/or hardware, and can generally be integrated in an electronic device. interface switching can be performed by performing a method for switching an interface. As shown in FIG. 9, the device includes:
an action area determining module 901 configured to, in a case that a first interface is currently displayed in a preset application, receive a swiping operation for the first interface and determine a target action area corresponding to the swiping operation, wherein an interface type of the first interface is a first type, and the first interface contains a first preset area and a second preset area; and
an interface switching module 902 configured to, in response to the swiping operation, switch to display a target interface, where, in a case that the target action area is a first preset area, the target interface is a second interface, in a case that the target action area is a second preset area, the target interface is a third interface, an interface type of the second interface is the first type, and an interface type of the third interface is a second type, and the first type and the second type are different.

The apparatus for switching an interface provided in the present disclosure receives, in a case that a first interface is currently displayed in a preset application, a swiping operation for the first interface and determines a target action area corresponding to the swiping operation and in response to the swiping operation, switching to display a target interface. An interface type of the first interface is a first type, and the first interface contains a first preset area and a second preset area, and in a case that the target action area is a first preset area, the target interface is a second interface, in a case that the target action area is a second preset area, the target interface is a third interface. The interface type of the second interface is the first type, and the interface type of the third interface is a second type. By adopting the above technical solution, different forms of interface switching can be performed using the swiping operation, and switching between interfaces of the same type or different types of interfaces can be determined according to the target action area corresponding to the swiping operation, which ensures the convenience of operation, and at the same time meets different switching needs, and improves the interface switching efficiency as well as the application performance.

For example, the apparatus further includes:
a swiping prompt information display module configured to display swiping prompt information within a first preset range corresponding to the second preset area before switching to display the third interface, wherein the swiping prompt information includes at least one of swiping direction information and swiping result indication information, and the swiping result indication information is configured to indicate it is about to switch to display the third interface.

For example, the swiping prompt information display module configured to display the swiping prompt information within the preset range of the second preset area after detecting a touch operation acting on the second preset area.

For example, the first preset control in the first interface is displayed in the second preset area, and in a case that the target action area is the second preset area, an action starting point of the swiping operation falls within an associated range of a display area corresponding to the first preset control, and the associated range includes the display area.

For example, the apparatus further includes:
a move and display controlling module configured to control the first preset control to move and display within a second preset range corresponding to the second preset area by following the swiping operation, before switching to display the third interface.

For example, the preset application is installed within a mobile terminal, and the second preset area is associated with a gripping mode when a user grips the mobile terminal.

For example, the apparatus further includes:
a second preset area determining module configured to determine a corresponding second preset area according to the gripping mode in which the user grips the mobile terminal, wherein the gripping mode comprises a left hand gripping and/or right hand gripping.

For example, the apparatus further includes:
a second preset control displaying module configured to display a second preset control in the determined second preset area in the first interface, where, in a case that the target action area is a second preset area, the action starting point of the swiping operation falls within a display area corresponding to the second preset control, the second preset control is determined based on the gripping mode in which the user grips the mobile terminal.

For example, the preset application program includes at least two interfaces of the first type, the at least two interfaces of the first type are sequentially switchable by the swiping operation, where at least one interface of the first type is switched to display an interface of the second type, in a case that the target action area corresponding to the swiping operation is the first preset area.

For example, the first type includes a tab type.

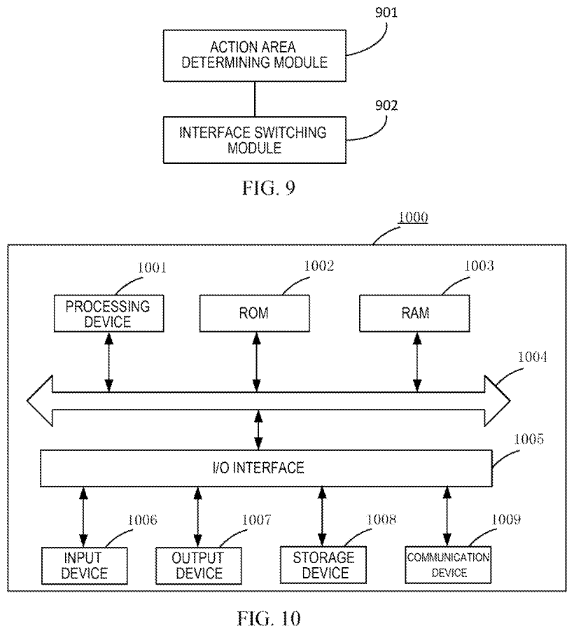

Referring to FIG. 10 below, it shows a structural schematic diagram of an electronic device 1000 suitable for implementing the embodiment of the present disclosure. The terminal device in the embodiment of the present disclosure may include but is not limited to mobile terminals such as mobile phones, laptops, digital broadcast receivers, Personal Digital Assistants (PDAs), tablet computers (PADs), portable multimedia players (PMPs), car-mounted terminals (such as car navigation terminals), etc. and fixed terminals such as digital televisions TV, desktop computers, etc. The electronic device shown in FIG. 10 is only an example and should not bring any limitation on the functionality and scope of use of the embodiment of the present disclosure.

As shown in FIG. 10, the electronic device 1000 may include a processing apparatus (such as a central processing unit, graphics processing unit, etc.) 1001, which may perform various appropriate actions and processes based on programs stored in Read-Only Memory (ROM) 1002 or loaded from storage apparatus 508 into Random Access Memory (RAM) 1003. In the RAM 1003, various programs and data necessary for the operation of the electronic device 1000 are also stored. The processing apparatus 1001, ROM 1002, and RAM 1003 are connected to each other through a bus 1004. An Input/Output I/O interface 1005 is also connected to the bus 1004.

Typically, the following apparatuses can be connected to I/O interface 1005: input apparatuses 1006 including, for example, touch screens, touchpads, keyboards, mice, cameras, microphones, accelerometers, gyroscopes, etc.; output apparatuses 507 including LCDs (liquid crystal displays), speakers, vibrators, etc.; storage apparatuses 1008 including magnetic tapes, hard disks, etc.; and a communication apparatus 1009. The communication apparatus 1009 may allow the electronic device 1000 to communicate with other apparatuses wirelessly or wirelessly to exchange data. Although FIG. 10 shows an electronic device 1000 with a plurality of apparatuses, it shall be understood that it is not required to implement or have all of the apparatuses shown. More or fewer apparatuses can be implemented or provided instead.

According to embodiments of the present disclosure, the process described above with reference to the flowchart can be implemented as a computer software program. For example, an embodiment of the present disclosure includes a computer program product that includes a computer program carried on a non-transitory computer-readable medium, where the computer program includes program code configured for performing the method shown in the flowchart. In such an embodiment, the computer program can be downloaded and installed from a network through the communication apparatus 1009, or installed from the storage apparatus 1008, or installed from the ROM 1002. When the computer program is executed by the processing apparatus 1001, the above functions defined in the method of the embodiment of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, radio frequency (RF), etc., or any suitable combination thereof.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device: in a case that a first interface is currently displayed in a preset application, receiving a swiping operation for the first interface and determining a target action area corresponding to the swiping operation, where an interface type of the first interface is a first type, and the first interface contains a first preset area and a second preset area; and in response to the swiping operation, switching to display a target interface, where, in a case that the target action area is a first preset area, the target interface is a second interface, in a case that the target action area is a second preset area, the target interface is a third interface, an interface type of the second interface is the first type, and an interface type of the third interface is a second type, and the first type and the second type are different.

Computer program codes for performing the operations of the present disclosure may be written in one or more programming languages or a combination thereof, including but not limited to Object Oriented programming languages—such as Java, Smalltalk, C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including local area network (LAN) or wide area network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to a plurality of embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The modules described in the embodiments of the present disclosure may be implemented by means of software or hardware, and the name of the module does not constitute a limitation on the module itself in a certain case, for example, a action area determining module may also be described as “a module for receiving a swiping operation for the first interface and determine a target action area corresponding to the swiping operation, in a case that a first interface is currently displayed in a preset application, wherein an interface type of the first interface is a first type, and the first interface contains a first preset area and a second preset area”.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, there is provided an interface switching method, including:
in a case that the first interface is currently displayed in the preset application, receiving a swiping operation for the first interface and determining a target action area corresponding to the swiping operation, wherein an interface type of the first interface is a first type, and the first interface contains a first preset area and a second preset area; and
in response to the swiping operation, switching to display a target interface, wherein, in a case that the target action area is a first preset area, the target interface is a second interface, in a case that the target action area is a second preset area, the target interface is a third interface, an interface type of the second interface is the first type, and an interface type of the third interface is a second type, and the first type and the second type are different.

For example, a first preset control in the first interface is displayed in the second preset area, and in a case that determining that the target action area is the second preset area, an action starting point of the swiping operation falls within an associated range of a display area corresponding to the first preset control, and the associated range includes the display area.

For example, before switching to displaying the third interface, the method also includes:
controlling the first preset control to move and display within a second preset range corresponding to the second preset area by following the swiping operation.

For example, the preset application is installed within a mobile terminal, and the second preset area is associated with a gripping mode when a user grips the mobile terminal.

For example, the method further includes:
determining a corresponding second preset area according to the gripping mode in which the user grips the mobile terminal, wherein the gripping mode comprises at left hand gripping and/or right hand gripping.

For example, the method further includes:
displaying a second preset control in the determined second preset area in the first interface, where, in a case that the target action area is a second preset area, the action starting point of the swiping operation falls within a display area corresponding to the second preset control, the second preset control is determined based on the gripping mode in which the user grips the mobile terminal.

For example, the first type includes a tab type.

For example, the preset application includes at least two interfaces of the first type, the at least two interfaces of the first type are sequentially switchable by the swiping operation, where at least one interface of the first type is switched to display an interface of the second type in a case that the target action area corresponding to the swiping operation is the first preset area.

For example, before switching to display the third interface, the method further includes:
displaying swiping prompt information within a first preset range corresponding to the second preset area, where the swiping prompt information includes at least one of swiping direction information and swiping result indication information, and the swiping result indication information is configured to indicate that it is about to switch to display the third interface.

For example, displaying the swiping prompt information within the first preset range of the second preset area, includes:
after detecting a touch operation acting on the second preset area, displaying the swiping prompt information within a preset range of the second preset area.

According to one or more embodiments of the present disclosure, there is provided an apparatus for switching an interface, including:
an action area determining module configured to, in a case that a first interface is currently displayed in a preset application, receive a swiping operation for the first interface and determine a target action area corresponding to the swiping operation, wherein an interface type of the first interface is a first type, and the first interface contains a first preset area and a second preset area; and
an interface switching module configured to, in response to the swiping operation, switch to display a target interface, wherein, in a case that the target action area is a first preset area, the target interface is a second interface, in a case that the target action area is a second preset area, the target interface is a third interface, an interface type of the second interface is the first type, and an interface type of the third interface is a second type, and the first type and the second type are different.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

1. A method for interface switching, comprising:
in response to determining that a first interface is currently displayed, receiving a swiping for the first interface and determining a target action area corresponding to the swiping, wherein an interface type of the first interface is a first type, and the first interface contains a first preset area and a second preset area; and
in response to the swiping, switching to display a target interface, wherein, in response to determining that the target action area is a first preset area, the target interface is a second interface, and in response to determining that the target action area is a second preset area, the target interface is a third interface, an interface type of the second interface is the first type, and an interface type of the third interface is a second type, and the first type and the second type are different.

2. The method of claim 1, wherein a first preset control in the first interface is displayed in the second preset area, and in response to determining that the target action area is the second preset area, an action starting point of the swiping falls within an associated range of a display area corresponding to the first preset control, and the associated range includes the display area.

3. The method of claim 2, before switching to display the third interface, the method further comprising:
controlling the first preset control to move and display within a second preset range corresponding to the second preset area by following the swiping.

4. The method of claim 1, wherein the preset application is installed within a mobile terminal, and the second preset area is associated with a gripping mode when a user grips the mobile terminal.

5. The method of claim 4, further comprising:
determining a corresponding second preset area according to the gripping mode in which the user grips the mobile terminal, wherein the gripping mode comprises at least one of left hand gripping and right hand gripping.

6. The method of claim 5, further comprising:
displaying a second preset control in the determined second preset area in the first interface, wherein, in response to determining that the target action area is a second preset area, the action starting point of the swiping falls within a display area corresponding to the second preset control, the second preset control is determined based on the gripping mode in which the user grips the mobile terminal.

7. The method of claim 1, wherein the preset application comprises at least two interfaces of the first type, the at least two interfaces of the first type are sequentially switchable by the swiping, wherein at least one interface of the first type is switched to display an interface of the second type in response to determining that the target action area corresponding to the swiping is the first preset area.

8. The method of claim 1, before switching to display the third interface, further comprising:
displaying swiping prompt information within a first preset range corresponding to the second preset area, wherein the swiping prompt information includes at least one of swiping direction information and swiping result indication information, and the swiping result indication information is configured to indicate that it is about to switch to display the third interface.

9. The method of claim 8, wherein displaying the swiping prompt information within the first preset range of the second preset area comprising:
in response to determining that a touch acting on the second preset area is detected, displaying the swiping prompt information within a preset range of the second preset area.

10. (canceled)

11. (canceled)

12. An electronic device comprising a memory, a processor, and a computer program, wherein the computer program is stored on the memory and is runnable on the processor, and the processor, when executing the computer program, implements acts for interface switching, the acts comprising:
in response to determining that a first interface is currently displayed in a preset application, receiving a swiping for the first interface and determining a target action area corresponding to the swiping, wherein an interface type of the first interface is a first type, and the first interface contains a first preset area and a second preset area; and
in response to the swiping, switching to display a target interface, wherein, in response to determining that the target action area is a first preset area, the target interface is a second interface, and in response to determining that the target action area is a second preset area, the target interface is a third interface, an interface type of the second interface is the first type, and an interface type of the third interface is a second type, and the first type and the second type are different.

13. (canceled)

14. The device of claim 12, wherein a first preset control in the first interface is displayed in the second preset area, and in response to determining that the target action area is the second preset area, an action starting point of the swiping falls within an associated range of a display area corresponding to the first preset control, and the associated range includes the display area.

15. The device of claim 14, before switching to display the third interface, the acts further comprising:
controlling the first preset control to move and display within a second preset range corresponding to the second preset area by following the swiping.

16. The device of claim 12, wherein the preset application is installed within a mobile terminal, and the second preset area is associated with a gripping mode when a user grips the mobile terminal.

17. The device of claim 16, the acts further comprising:
determining a corresponding second preset area according to the gripping mode in which the user grips the mobile terminal, wherein the gripping mode comprises at least one of left hand gripping and right hand gripping.

18. The device of claim 17, the acts further comprising:
displaying a second preset control in the determined second preset area in the first interface, wherein, in response to determining that the target action area is a second preset area, the action starting point of the swiping falls within a display area corresponding to the second preset control, the second preset control is determined based on the gripping mode in which the user grips the mobile terminal.

19. The device of claim 12, wherein the preset application comprises at least two interfaces of the first type, the at least two interfaces of the first type are sequentially switchable by the swiping, wherein at least one interface of the first type is switched to display an interface of the second type in response to determining that the target action area corresponding to the swiping is the first preset area.

20. The device of claim 12, before switching to display the third interface, the acts further comprising:
displaying swiping prompt information within a first preset range corresponding to the second preset area, wherein the swiping prompt information includes at least one of swiping direction information and swiping result indication information, and the swiping result indication information is configured to indicate that it is about to switch to display the third interface.

21. The device of claim 20, wherein displaying the swiping prompt information within the first preset range of the second preset area comprising:
in response to determining that a touch acting on the second preset area is detected, displaying the swiping prompt information within a preset range of the second preset area.

22. A non-transitory computer-readable storage medium having a computer program stored thereon, wherein the computer program, when being executed by a processor, implements acts for interface switching, the acts comprising:
in response to determining that a first interface is currently displayed in a preset application, receiving a swiping for the first interface and determining a target action area corresponding to the swiping, wherein an interface type of the first interface is a first type, and the first interface contains a first preset area and a second preset area; and
in response to the swiping, switching to display a target interface, wherein, in response to determining that the target action area is a first preset area, the target interface is a second interface, and in response to determining that the target action area is a second preset area, the target interface is a third interface, an interface type of the second interface is the first type, and an interface type of the third interface is a second type, and the first type and the second type are different.

23. The medium of claim 22, wherein a first preset control in the first interface is displayed in the second preset area, and in response to determining that the target action area is the second preset area, an action starting point of the swiping falls within an associated range of a display area corresponding to the first preset control, and the associated range includes the display area.
